(19) United States
(12) Patent Application Publication
(10) Pub. No.: US 2021/0035026 A1
(43) Pub. Date: Feb. 4, 2021

(54) DIAGNOSING & TRIAGING PERFORMANCE ISSUES IN LARGE-SCALE SERVICES

(71) Applicant: Microsoft Technology Licensing, LLC, Redmond, WA (US)

(72) Inventors: Chetan BANSAL, Seattle, WA (US); Ashima ASUDANI, Sammamish, WA (US); Olivier MIDY, Belleview, WA (US)

(73) Assignee: Microsoft Technology Licensing, LLC, Redmond, WA (US)

(21) Appl. No.: 16/527,968

(22) Filed: Jul. 31, 2019

(51) Int. Cl. G06N 20/20; G06N 5/02

(52) U.S. Cl. CPC G06N 20/20; G06N 5/025

(57) ABSTRACT

Technology for diagnosing and triaging performance issues in large-scale services. Example processes include accessing log data and performance indicator data, for a plurality of computing devices, for a defined period of time. A random forest model is trained with the aggregated log data and the aggregated performance indicator data to generate a plurality of trained decision trees. The decision trees include a plurality of nodes represented by predicates. A correlation score for a node in the plurality of decision trees is determined, and based on the determined correlation score, a rule is extracted for the node based on the predicate. The extracted rule is triaged based on previously extracted rules for a time period prior to the defined period of time.

### BACKGROUND

The move from boxed software to cloud services has changed how software products are built and deployed. The transition has simplified critical aspects of software development like shipping updates and compatibility with client hardware. Cloud computing has also introduced a new role of engineers in development and operations (DevOps) where the service owners are responsible and accountable for monitoring key performance indicators (KPIs) and resolving underlying errors that negatively effects the KPIs. Large scale cloud services companies like Microsoft, Amazon, Facebook, and Google have hundreds of cloud services powering consumer and enterprise apps and websites. These cloud services use KPIs like latency, failure rate, availability, uptime, etc. to continuously monitor service health and user satisfaction. Dependency failures, code bugs, infrastructure failures, and other problems can cause performance regressions in those KPIs. It is important to minimize the time and effort in diagnosing & triaging such computing issues to reduce negative impacts.

It is with respect to these and other general considerations that embodiments have been described. Also, although relatively specific problems have been discussed, it should be understood that the embodiments should not be limited to solving the specific problems identified in the background.

### SUMMARY

The present technology provides for systems and methods for automated diagnosis and triaging of KPI issues using service logs. The technology identifies root causes for problems with key performance indicators (KPIs), such as latency. For instance, the technology analyzes log data and KPI data to determine what events/attributes in the log data causes KPI issues, such as increased latency. To identify the attributes, the technology trains a random forest based on the log data and the KPIs recorded for a particular time period. Instead of using that trained random forest to predict future results like most machine-learning techniques, however, the present technology extracts rules directly from the decision trees in the random forest themselves. The extracted rules are indicative of the root cause of a KPI regression and performance issues.

As an example, each trained decision tree in the random forest includes nodes that are represented by a predicate, which may be represented by a true/false Boolean function (e.g., P:X→{true, false} is referred to as a predicate on X). One example predicate generated from log data may be Region:EUR, where one branch from that node would be where the region of Europe is true and the other branch from the node would be where the region of Europe is false. For each node, the KPI data for the true branch is compared with the KPI of the false branch. If the KPI data for the true branch is different from the KPI data of the false branch, that node may be affecting the KPI. Accordingly, the predicate for the node is extracted as a rule that indicates a root cause of a KPI regression. The extracted rule may then be triaged based on previously extracted rules for a previous time period prior to the defined period of time. Triaging the rule may include triaging the rule into one or more of the following triage categories: new, known, regressed, or improved.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 depicts an example system and workflow for diagnosing and triaging performance issues.

FIG. 2A depicts an example decision tree according to the present technology.

FIG. 2B depicts an example regression tree according to the present technology.

FIG. 2C depicts an example classification tree according to the present technology.

FIG. 3A depicts an example report of extracted rules.

FIG. 3B depicts another example report of extracted rules.

FIG. 3C depicts an example interface for analyzing diagnostics.

FIG. 4A depicts an example method for diagnosing performance issues.

FIG. 4B depicts an example method for determining a correlation score for a node.

FIG. 4C depicts an example method for triaging extracted rules.

FIG. 5 is a block diagram illustrating example physical components of a computing device with which aspects of the disclosure may be practiced.

FIGS. 6A and 6B are simplified block diagrams of a mobile computing device with which aspects of the present disclosure may be practiced.

FIG. 7 is a simplified block diagram of a distributed computing system in which aspects of the present disclosure may be practiced.

FIG. 8 illustrates a tablet computing device for executing one or more aspects of the present disclosure.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

As discussed above, large scale cloud services companies like Microsoft, Amazon, Facebook, and Google have hundreds of cloud services powering consumer and enterprise apps and websites. These cloud services use KPIs like latency, failure rate, availability, uptime, etc. to continuously monitor service health and user satisfaction. Such KPIs may be defined in service level agreements (SLAs). Identifying performance issues and the root causes behind the performance issues, however, has continued to be a challenge—especially as cloud services continue to grow and process massive amounts of data. The resultant large volumes of logs and mixed type of attributes (categorical and continuous) makes any automated or manual diagnosing incredibly difficult. For example, performance degradation can be due to large amounts of various reasons, such as code bugs, infrastructure failure or overload, design gaps, and dependency failures. Those issues may also be local or global depending on various factors such as the root cause, deployment scope, etc. For instance, a hardware failure in a data center can increase the load on the other servers, degrading the request latency for that data center. Similarly, a thread contention bug can impact the performance of the entire service. Properly identifying such issues and root causes is a critical aspect in resolving performance regressions and improving the functioning of the underlying computing devices.

While root cause analysis and diagnosing performance issues in distributed systems has been a studied problem in Systems and Software Engineering communities, the prior solutions still have significant limitations. For instance, existing work on log based performance diagnosis for services mainly relies on either anomaly detection or association rule mining based methods. The present technology, however, provides an improved approach over those processes. For example, anomaly detection methods cannot scale to high dimensional and high cardinality data, and anomaly detection methods also fail to detect pre-existing performance issues. Similarly, association rule mining based methods are not applicable to data with continuous attributes and KPIs, for instance, latency. In addition, high dimensional and high cardinality data leads to a combinatorial explosion. The present technology, among providing other benefits, is able to overcome these issues and provide an end-to-end system for diagnosing and triaging performance issues in large scale services.

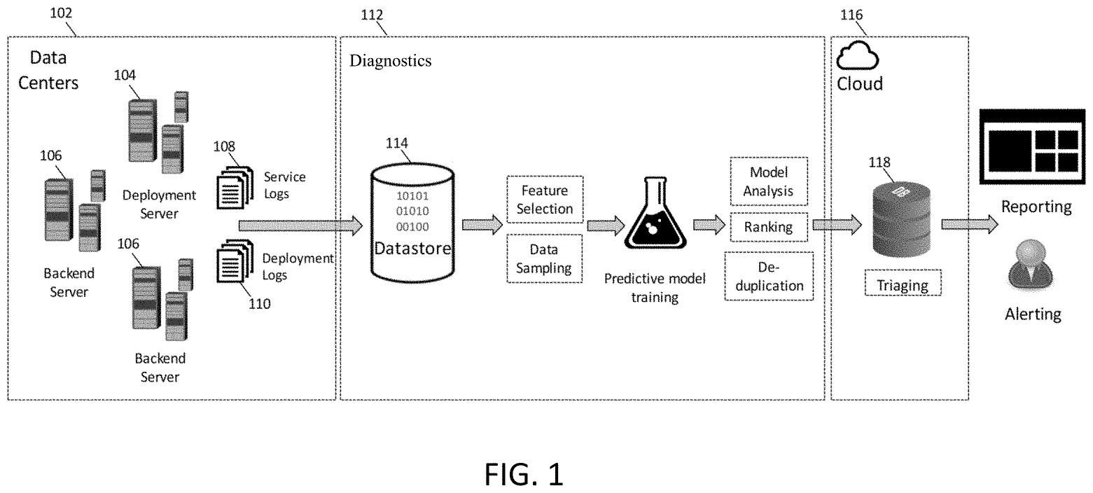

FIG. 1 depicts an example system 100 and a workflow for the components of the system 100. The system 100 may include one or more data centers 102 that include a plurality of servers, such as deployment servers 104 and backend servers 106. The servers in the data centers generate log data, such as service log data 108 and deployment log data 110. The log data may include key request attributes and metrics, among other log data. The attributes in the log data may be of mixed types, such as categorical log data and continuous log data. For example, latency is a continuous metric, and request status is a binary categorical metric (success or fail). The log data may also contain both structured and unstructured information. For example, attributes which are useful for monitoring and large-scale diagnosis (such as backend server, component latencies, etc.) may be logged in a structured manner. Information like exception stack traces used for diagnosing request level problems may be serialized and logged in an unstructured format. In some examples, the data centers produce massive volumes of logs, on the order of 1 TB per hour. The attributes within the log data also often have high cardinality for large scale services. Cardinality of an attribute is the number of possible values that the attribute may have. For example, where an attribute is UserID and thousands of different users are sending requests, the cardinality of that attribute is in the thousands. The following Table 1 lists some example attributes within log data, the corresponding type of the attribute, and the approximate order of the cardinality for the attribute:

TABLE 1
Example Attributes From Log Data

| Attribute | Type | Cardinality |
|---|---|---|
| Organization | Categorical | O(1M) |
| Server | Categorical | O(10K) |
| ApiPath | Categorical | O(1K) |
| AppId | Categorical | O(100) |
| CapacityUnit | Categorical | O(100) |
| UserAgent | Categorical | O(100) |
| DataCenterTarget | Categorical | O(10) |
| DataCenterOrigin | Categorical | O(10) |
| Forest | Categorical | O(10) |
| UserCategory | Categorical | O(10) |
| BuildVersion | Categorical | O(10) |
| Module1 L1 Cache Latency | Continuous | — |
| Module1 L2 Cache Latency | Continuous | — |
| EndPoint1 Latency | Continuous | — |
| EndPoint2 Latency | Continuous | — |
| Auth Latency | Continuous | — |

The system 100 also includes a diagnostics subsystem 112 where training of the machine learning models and rule extraction occurs. The diagnostics subsystem 112 may located on one or more computing devices remote from the data centers 102, or in some examples, the diagnostics subsystem 112 may be located within one of the data centers 102. The diagnostics subsystem may include a data store 114. The data store 114 may periodically receive and aggregate the log data generated by the data centers. The data store may be a Hadoop Distributed File System (HDFS)—like massive data store with a Hadoop-like map reduce system for data analytics.

The diagnostics subsystem 112 may perform feature selection and data sampling on the log data for use in training the machine-learning model, such as random forest. Feature selection and data sampling may be performed in examples with large amounts of log data to reduce the training time of the machine-learning model. For instance, data centers 102 hosting cloud services can generate hundreds of terabytes of data every day and log hundreds of attributes. Such a large amount of data makes any analysis challenging both in terms of space and time. To help alleviate that problem, data sampling and feature selection processes may be leveraged. Feature selection may also be used to eliminate features that are not helpful because not all features present in the log data are useful for determine the root cause of performance issues. For instance, features such as Request Id or Correlation Id, which uniquely identifies individual rows, are not useful in identifying root causes for widespread issues. Those features may also have very high cardinality and can cause state explosion. For instance, as the as the number of state variables in the system increases, the size of the system state space grows exponentially. To be able to select the right features, service owners may use domain knowledge built on investigations of past incidents. Automated feature selection may also be performed based on prior manual feature selections. In addition, to further assist in the feature selection process, the present technology is also capable of automatically classifying features into continuous & categorical features and measuring the cardinality of the categorical variables. Service owners may then use the cardinality distribution as an aid in feature selection. Data sampling processes may also be performed before or after the feature selection processes have been performed. Different types of data sampling may be utilized, such as random sampling, systematic sampling, stratified sampling, cluster sampling, etc.

The log data may also be pre-processed and stratified. Pre-processing of the log data may be performed where distributed across multiple data streams. For instance, different components of a service may write logs to different data stores while logging a distinct correlation Id per request to help join the logs at a later stage. Thus, as a one-time step, queries for aggregating/joining data from various streams/sources may be written and aggregated. In some instances, the data may also be serialized while being logged. In such instances, the log data may be de-serialized into a structured schema before being further processed by the present technology. Stratification may also be performed. Stratification is the process of dividing the data into mutually exclusive, homogeneous, and collectively exhaustive subsets or classes. While it is possible to have multiple classes in stratification, in some examples the present technology may consider only binary classes. For example, service requests may be divided into two classes—a positive class and a negative class. The positive class includes requests showing anomalous behavior or violating the performance standards for the KPIs. The negative class includes requests which meet the KPI standards. The stratification criteria may be determined by the particular standards for the KPI. For example, the KPI standard may be a maximum 5 millisecond (ms) latency. Accordingly, requests having a RequestLatency greater than 5 ms may be classified in the positive class and requests having a RequestLatency less than or equal to 5 ms may be classified in the negative class. Performing the pre-processing, feature selection, stratification, and/or data sampling processes results in a subset of log data that may be referred to as the processed log data.

The diagnostics subsystem 112 trains a machine-learning model based on the processed log data. The machine-learning model primarily used in the present technology is a random forest model. The random forest model is an ensemble machine-learning method for classification and regression that operates by constructing a multitude of decision trees. To train the random forest, the present technology may use a particular KPI, such as latency or failure rate, as the target attribute and the rest of the log attributes as the features or independent variables. Different random forests may be trained for different KPIs. Unlike conventional machine learning applications, however, the present technology does not use the trained models for prediction. Rather, the present technology analyzes the trained models to extract predicates that cause performance regressions.

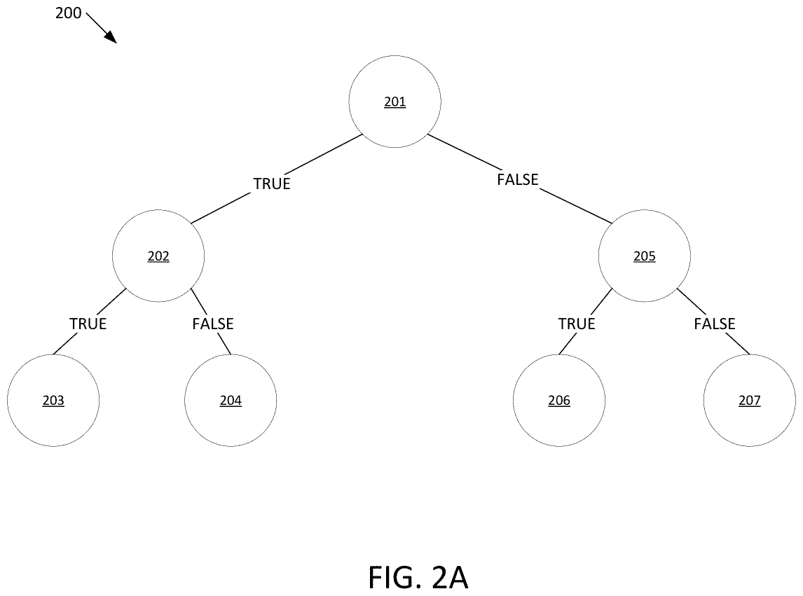

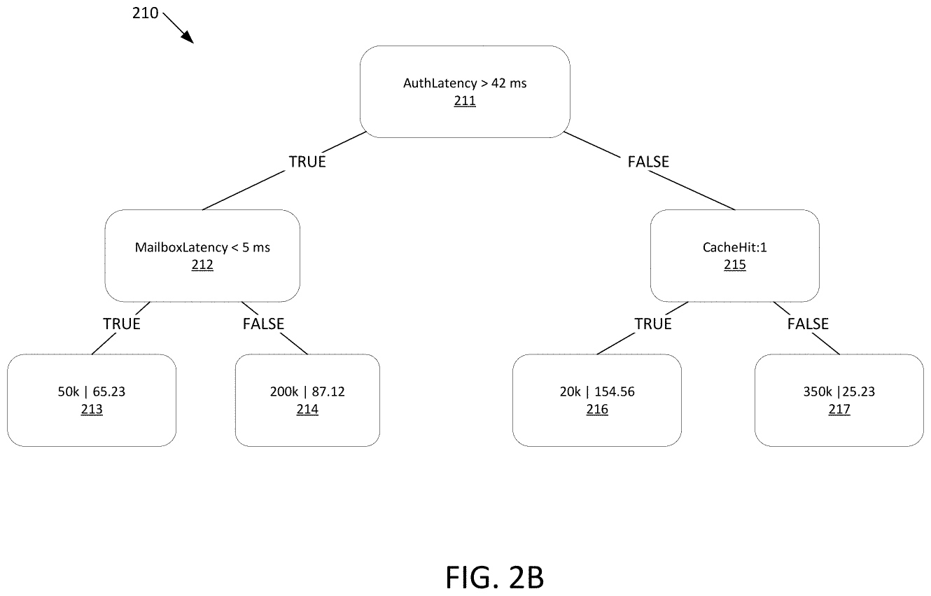

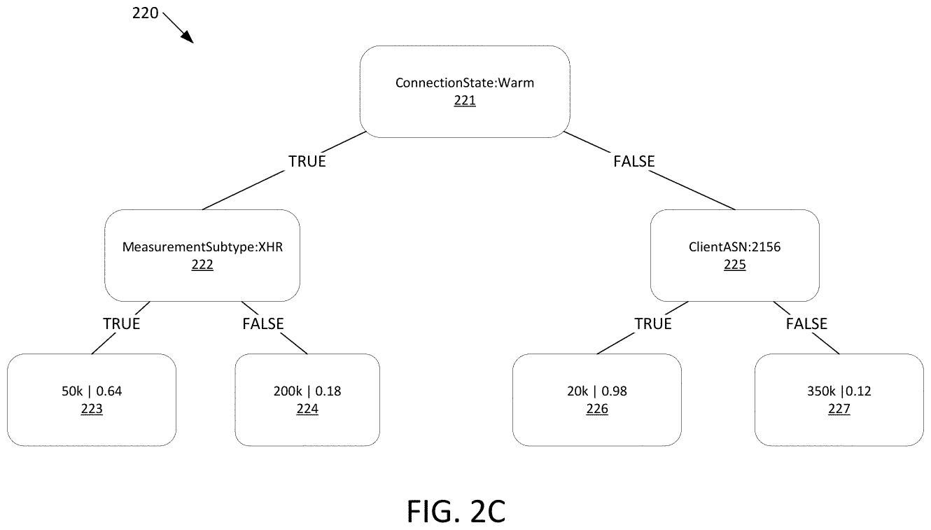

A decision tree consists of a set of split or decision nodes and leaf nodes where each decision or split node is defined by a predicate. Essentially, decision trees are a hierarchy of nodes in the form of a tree. An example decision tree 200 is shown in FIG. 2A. The example decision tree includes a series of nodes 201-207, with node 201 being the root node and nodes 203-204 and 206-207 being leaf nodes. Data is partitioned based on a predicate for each root and decision node. During training of the decision tree, the best predicate for each node is determined for partitioning the data and the process is repeated as nodes are added to the decision tree 200. For instance, all data that satisfies the predicate of node 201 is then considered in node 202. All data that satisfies the predicate of node 202 is considered in node 203. In contrast, all data that does not satisfy the predicate of node 201 in considered in node 205. Decision trees can be used for both categorical and continuous target variables. If the target variable is categorical, classification trees are used; if it is continuous, regression trees are used. Both classification and regression trees may be trained from the log data.

Classification trees are used to predict categorical target variables (for instance, weather-outlook: rain or sunny). At the training time, classification trees maximize the information gain at each split by reducing the entropy of the partitioned data after the split. Information gain when the tree is split on attribute Aᵢ is defined as:

$$IG ( S , {A}_{J} ) = H ( S ) - {\sum }_{{A}_{i} ∈ A} \frac{\vert {A}_{i} \vert}{s} H ( {A}_{i} )$$

where H(S), the entropy set of S, is defined as:

H(S)=−Σ_{c∈C}p_{c} log₂ p_{c},

where p_{c} is the probability of S for the class c.

Regression trees are used to predict continuous variables, for instance, latency. Unlike classification trees, instead of maximizing information gain, regression trees minimize the mean squared error (MSE) at each split:

$$M S E = \frac{1}{n} {\sum }_{i = 1}^{n} {( {y}_{i} - {\hat{y}}_{i} )}^{2} ,$$

Where yᵢ is the actual value of the target variable and ŷᵢ is the predicted value.

FIG. 2B depicts an example regression tree 210, and FIG. 2C depicts an example classification tree 220. The example regression tree 210 in FIG. 2B includes a plurality of nodes 211-217 and was trained for a target variable of total request latency and based on a set of attributes or features that correspond to features selected from the log data in the feature selection operations. Accordingly, each predicate in the nodes of the tree 210 corresponds to an attribute in the log data. The example root node 211 is represented by the predicate AuthLatency >42 ms. The decision node 212 on the TRUE branch from root node 211 is represented by the predicate MailboxLatency <5 ms. The decision node 212 may be considered a child node to the root note 211, and the root node 211 may be considered the parent node of the decision node 212. Two leaf nodes 213, 214 are attached to the TRUE and FALSE branch of the decision node 212 represent the latency on the right hand side of the node and the number of requests impacted on the left-hand side of the node. For instance, leaf node 213 indicates that 50,000 requests had a total request latency of 65.23 ms when the MailboxLatency was less than 5 ms and the AuthLatency was greater than 42 ms. Similarly, leaf node 213 indicates that 200,000 requests had a total request latency of 87.12 ms when the MailboxLatency was greater than 5 ms and the AuthLatency was greater than 42 ms. The leaf nodes 216, 217 and the decision node 215 operate similarly for the other side of the example regression tree 210.

The example classification tree 220 in FIG. 2C includes nodes 221-227 and was trained for a target variable of request failure probability. The root node 221 includes of the predicate of ConnectionState:Warm. The decision node 222 on the TRUE branch from the root node 221 is represented by the predicate MeasurementSubtype:XHR. Two leaf nodes 223, 224 are attached to the TRUE and FALSE branch of the decision node 222 represent the failure probability on the right hand side of the node and the number of requests impacted on the left-hand side of the node. For instance, leaf node 223 indicates that 50,000 requests had a failure probability of 0.64 when the MeasurementSubtype was XHR and the ConnectionState was Warm. Similarly, leaf node 223 indicates that 200,000 requests had a failure probability of 0.18 when the MeasurementSubtype was not XHR and the ConnectionState was Warm. The leaf nodes 226, 227 and the decision node 225 operate similarly for the other side of the example classification tree 220.

The random forest model is comprised of multiple decision trees that may be either classification or regression trees. The random forest model is a useful machine learning model for the present technology for several reasons. As one reason, the random forest model is able to not only support both continuous and categorical features/attributes but also continuous and categorical target variables. The random forest model is also one of the most interpretable models, and it is highly scalable both in terms of feature cardinality and data volume. For instance, unlike a neural network, the random forest can be more easily parsed and even converted into a set of text objects. The random forest model is also easily parallelizable on a MapReduce systems like Hadoop and Spark. Further, the random forest model is also less prone to overfitting and performs better than a single decision tree.

Random forest models, like other machine learning models, have several hyper-parameters which may be tuned to improve the prediction accuracy and runtime performance. Work has been done previously to analyze the impact of the hyper-parameters on prediction accuracy, but the present technology does not use the model for prediction. Rather, the present technology uses the trained models for extracting rules for diagnosis of KPI regressions. As such, the previous work on hyper-parameter selection is less useful for the purposes of the present technology. Based on empirical experiments, however, several hyper-parameters and values of those hyper-parameters have been found useful for the present technology. The minimum rows in leaves hyper-parameter is one useful hyper-parameter. The minimum rows in leaves hyper-parameter specifies the minimum number of training data in a leaf to avoid overfitting. If a leaf node contains less than this threshold, it will not continue to split the training data. Thus, the tree will stop growing on that leaf. This helps reduce the noise by eliminating rules which impact very small number of requests. An example value for the minimum rows in leaves hyper-parameter is about 1% of the log size, however other sizes may also be utilized. Another useful hyper-parameter is the feature sample ratio hyper-parameter. The feature sample ratio hyper-parameter specifies the sampling ratio used for sampling features when generating each tree. For example, setting the sampling ratio to 1 will cause all trees in the forest to be identical. Based on empirical experiments a useful value for the sampling ratio has been found to be about 0.6, however other values may be used. Another hyper-parameter that has been found to be useful is the number of trees hyper-parameter. The number of trees hyper-parameter sets the number of trees to train. Increasing the number of trees increases the number of unique rules that may be extracted for diagnosis, but it also increases the training time. Fifty trees may be a useful value for the number of trees, however other values may be used where particular runtime constraints are present.

Returning to FIG. 1, once the random forest model is trained, the diagnostics subsystem 112 analyzes the model to extract one or more rules that are indicative of a root cause of performance regression or issue. As discussed above, the training the random forest model generates a plurality of regression and/or classification trees. The regression and/or classification trees may be converted into a format that is better suited for analysis or parsing. For example, the regression and/or classification trees may be converted into a text format if the regression and/or classification trees are not already in such a format. The text of the random forest may also be parsed into an in-memory set of decision tree objects representing the nodes. Each of the nodes may then be analyzed, starting from the root node.

At each node, an aggregate score of the left/true and the right/false sub-trees may be computed based on the performance indicator data for the sub-trees. For instance, where latency is the target KPI that is being analyzed, the average latency for all logs in the left sub-tree can be compared to the average latency for all logs in the right sub-tree. As an example, using the regression tree 210 from FIG. 2B, when node 212 is analyzed, the latency for the left/true branch is compared to the latency for the right/false branch. In that example, the latency of the left branch is 65.23 and the latency of the right branch is 87.12. The latency values used may be the average latency values. Comparing the latency from the left/true branch to the latency of the right/false branch may include subtracting the latency value of the right/false branch from the latency value of the left/true branch to determine a difference between the two latency values. The difference between the two values may be referred to as the correlation score for the node. If the correlation score is positive, that means that the predicate of the node being true is positively correlated with the performance regression (e.g., high latency). If the correlation score is negative, then the predicate of the node being true is negatively correlated with the performance regression.

Based on the correlation score of a node, the predicate of the node may be extracted. For instance, if the correlation score is greater than a predetermined threshold value, the predicate may be extracted as a rule. The rule may be presented in the form of the predicate itself, or the rule may be based on the predicate but presented in a different format. For example, rather than the predicate in its original format, the rule may expand the predicate beyond the abbreviated attribute to provide additional context for the predicate. Utilizing a threshold allows for noise in the model be excluded. For example, where the difference between the two performance indicator data is minimal, the predicate may not actually be affecting performance, or the performance affect may be minimal. As such, it may not be beneficial to extract the predicate.

Extracting the rule may include extracting the predicate of the node being analyzed, referred to as the correlated predicate, and extracting the predicate of the node and the predicates of each preceding node between the node being analyzed and the root node. For example, using the example regression tree 210 in FIG. 2B, the correlated predicate for node 212 is MailboxLatency <5 ms, and the scope predicate for node 212 is MailboxLatency <5 ms Λ AuthLatency >42 ms, where the A indicates a logical “and.” The extracted predicate is then stored in a rule set.

Because the random forest model produces multiple decision trees, it is possible that the same rule or predicate may be extracted multiple times. For instance, the same node made exist in multiple decision trees, and the predicate of that node may be extracted out of each tree. Accordingly, the diagnostics subsystem 112 may also de-duplicate the predicates that are extracted from the random forest model.

For each extracted rule or predicate, a performance impact may also be determined. The performance impact may be combination of the number or requests or users affected along with magnitude of the performance regression that was experience. For example, where 50,000 requests satisfy the scope predicate, the performance impact may be the number of requests that are received multiplied by the average latency for the requests that satisfy the scope predicate. The performance impact may also be determined by first calculating the difference between the average latency for the requests satisfying the scope predicate and the expected or standard value for the latency. In other examples, the performance impact may be based solely on the number of requests or the row count for the respective KPI that is being analyzed.

The extracted rules or predicates may then be ranked according the performance impact and/or correlation score. By ranking the extracted predicates, the rules or predicates that have the largest impacts can be more easily represented and the predicates having the highest impacts can be handled in order of impact. By ranking the extracted predicates based on the correlation score, the ranking is primarily based on the difference in the KPI values caused by the extracted predicate. By ranking the extracted predicates based on the performance impact, the number of requests or users impacted may also be taken into account.

Once the rules or predicates have been extracted from the random forest model, they extracted rules or predicates may be stored in a database 112 by a triaging subsystem 116. The extracted rules may be stored with their corresponding correlation score and/or performance impact. As rules are added to the database 112, the rules may also be triaged by the triaging subsystem 116. Triaging the rules includes classifying the rules into difference categories. For instance, the rule may be triaged as new, regressed, known, or improved. Triaging the incoming rules is based on the previously extracted rules that may be stored in the database. Statistical distributions for the frequency that rules been previously extracted and the distribution of the correlation scores and/or performance impacts may also be generated and stored in the database 112. For example, the extracted rule may be compared to previously extracted rules over a defined period of time, such as 14 days, one month, or any other period of time that is desired.

An extracted rule may be triaged as new when the extracted rule has not been previously stored in the database over the defined period of time. The extracted rule may be triaged as regressed if the correlation score and/or the performance impact of extracted rule is worse (e.g., higher latency) than the average correlation score and/or performance impact for rule in the defined previous period of time. In some examples, the extracted rule is triaged as regressed only if the correlation score and/or the performance impact of the newly extracted rule is at least one standard deviation away the average correlation score and/or the performance impact for the rule in the defined previous period of time. Similarly, the extracted rule may be triaged as improved if the correlation score and/or the performance impact of the extracted rule is better (e.g., reduced latency) than the average correlation score and/or performance impact for rule in the defined previous period of time. In some examples, the newly extracted rule is triaged as improved only if the correlation score and/or the performance impact of the newly extracted rule is at least one standard deviation away the average correlation score and/or the performance impact for the rule in the defined previous period of time. In some examples, the newly extracted rule is triaged as known if the correlation score and/or the performance impact for the newly extracted rule is within one standard deviation of the average correlation score and/or the performance impact for the rule in the defined previous period of time. The triaged rules may then be reported to a user or an engineer to take action to resolve the performance regressions based on the root causes indicated in the triaged rules. Alerts may also be generated when a new rule has been detected and/or when a rule has been triaged as regressed.

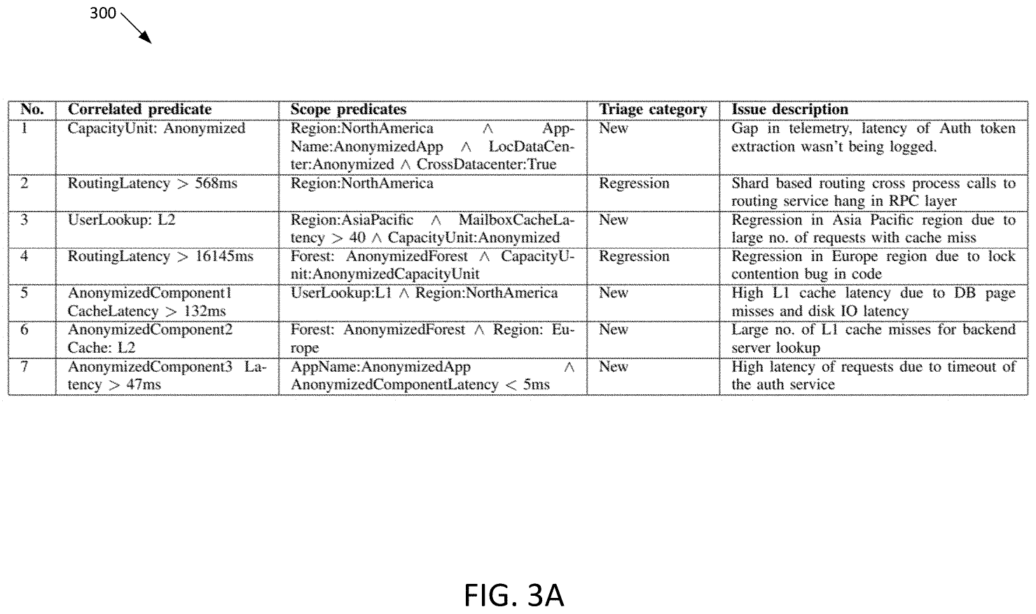

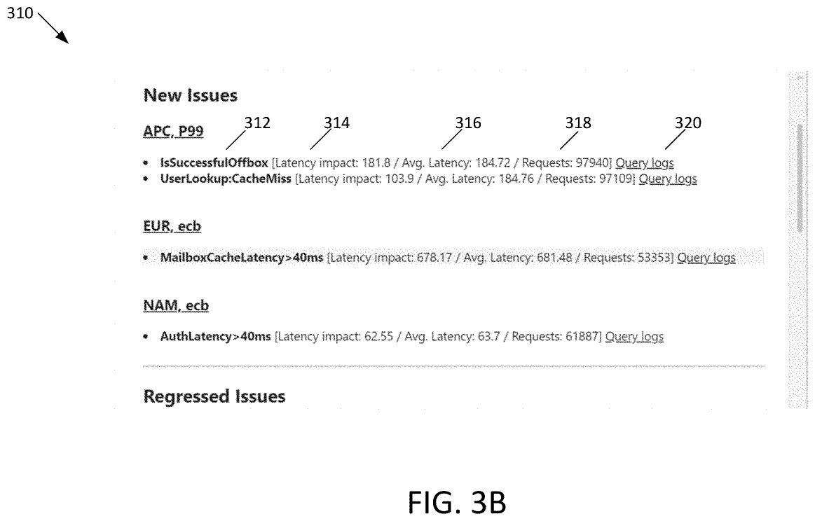

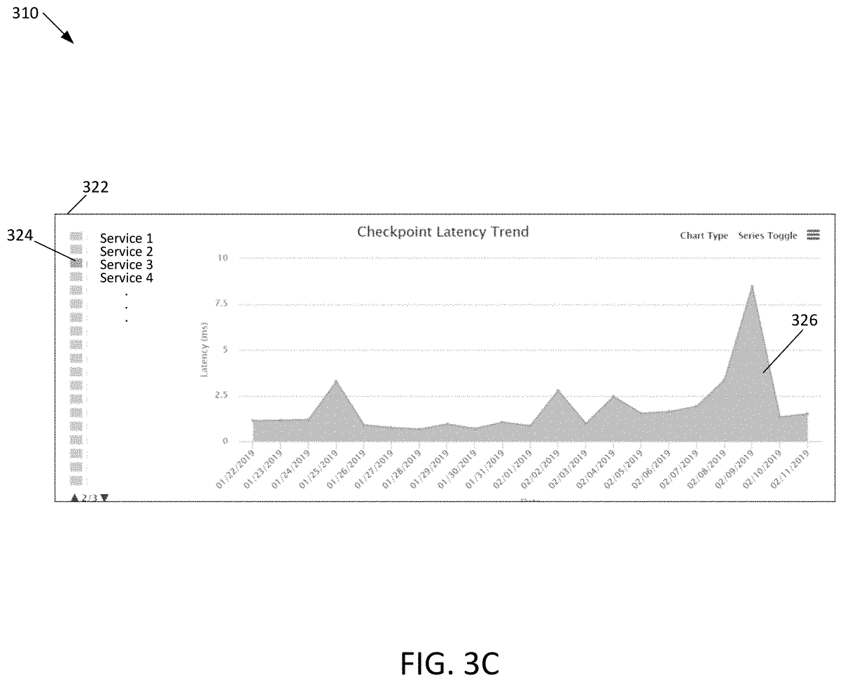

FIG. 3A depicts an example report 300 of triaged rules. A different rule is represented as a different row in the table of the report 300. The rule in Row 1 has a correlated predicate of CapacityUnit:Anonymized and scope predicates of Region:NorthAmerica A App-Name:AnonymizedApp Λ LocDataCenter:Anonymized Λ CrossDatacenter: True. Accordingly, the correlated predicate of Capacity Unit:Anonymized indicates that when the value of the attribute Capacity Unit is equal to Anonymized, there may be a performance regression. Such a correlated predicate was extracted from a decision tree having a node represented by the predicate CapacityUnit:Anonymized, and KPI value being worse when the predicate CapacityUnit:Anonymized was true (e.g., the left branch from the node) than when the predicate was false (e.g., the right branch from the node). The scope predicates for the rule indicate the predicates that were includes in each parent node of the decision tree including the root node. For example, for the rule represented in Row 1, the root node of the decision tree was represented by the predicate Region:NorthAmerica. The left/true branch of that root node connects to a first child node represented by the predicate App-Name:AnonymizedApp. The left/true branch of that first child node connects to a second child node represented by the predicate CrossDatacenter: True. The left/true branch of that second child node connects to a third child node represented by the predicate CrossDatacenter:True. The left/true branch of that third child node connects to a fourth child node that is represented by CapacityUnit:Anonymized, the correlated predicate.

For each rule, the triage category is also listed. For example, in the rule represented in Row 1, the triage category is new, meaning that the extracted correlated predicate has not been previously extracted within the defined period of time. In addition, an issue description section may be added to the table in the report 300 as well. The issue description section may provide additional context regarding the identified correlated predicate and the scope predicates. In some examples, the issue description may be automatically generated. The automatic generation of issue descriptions may be based on previously entered manual issue descriptions or pre-populated descriptions of attributes in the predicates.

FIG. 3B depicts another example report 310 for extracted rules. The report 310 may be delivered in an e-mail to engineer or other technician responsible for resolving performance issues. The report 310 may also be delivered as part of a dashboard that is accessible via a remote connection, such as through the Internet available through a browser or dedicated application. The report includes a plurality of rules that have been grouped by their triage category. In the example report 310, the extracted rules have been grouped as new or regressed, and another listing of top issues are provided in a ranked list. For each extracted rule, the correlated predicate 312 is provided. The KPI impact 314 is also displayed. The KPI impact may be the correlation score, which indicates the average worsening of the KPI per request, or the performance impact, which indicates the total or aggregate impact of the KPI performance regression. The average KPI metric 316 for the requests meeting the correlated predicate may also be listed. The total number of request 318 that meet the correlated predicate may also be displayed. In the example report 310, the target KPI is latency. The first listed rule has a correlated predicate 312 of IsSuccessfulOffbox, the latency impact 314 was 253.37, the average latency 316 was 254.52, and the number of requests was 64,226.

An automatic query generation and execution option 320 may also be presented for each of the rules included in the report. The option 320, when selected, automatically structures and executes a query of the log data based on the correlated predicate and the scope predicates for the respective rule. As an example, using Rule 1 from report 300 in FIG. 3A, that rule has a correlated predicate of CapacityUnit:Anonymized and scope predicates of Region:NorthAmerica A App-Name:AnonymizedApp A LocDataCenter:Anonymized A CrossDatacenter: True. Accordingly, upon selection of the option 320 for that rule, a query would be structured to return all log data that satisfies the correlated predicate and the scope predicates. Selection of the option 320 may also execute the structured query against the log data to return the logs. Such an automatic query structuring provides a substantial improvement over prior manual filtering of data logs and is made possible through the particular type of rule extraction from the random forest performed by the present technology.

FIG. 3C depicts an example interface 322 for analyzing diagnostics. The interface includes a plurality of selectable services 324 that can be analyzed using the interface 322. When a service is selected, a plot 326 of a KPI is depicted over time. In the example interface 322, the service 324 selected is Service 3 and a plot 326 of the latency is shown over time. As can be seen in the plot 326, there was a performance regression between about Feb. 7, 2019 and Feb. 10, 2019. Thus, an engineer would be interested in investigating the root causes for that performance regression over that time period. Through the interface 322, a user such as an engineer may select a starting date/time and an end/date time and the rule extraction process of the present technology is be performed based on the selected time range. The selected time range may be entered into the interface 322 by first selecting the start date then selecting the end data by clicking or otherwise selecting each date in the x-axis of the plot 326. In other examples, a dragging motion across the plot may be used to select the time range. In yet other examples, a box or other shape may be drawn around the portion of the plot 326 that is of interest to the user. The start and end times are then auto-generated from the drawn shape to define the time range or period that should be analyzed for rule extraction.

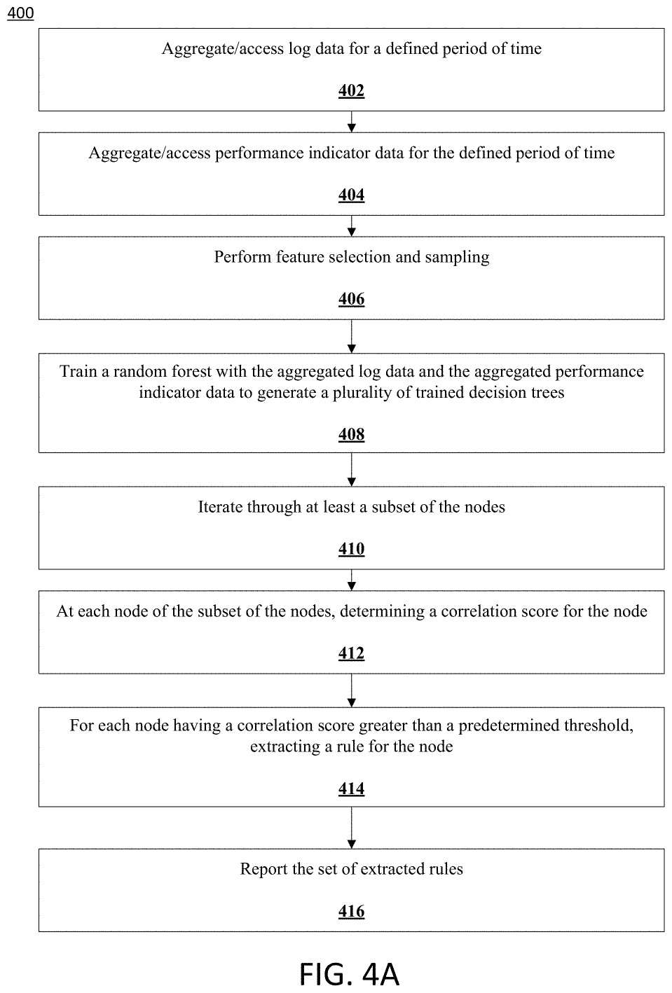

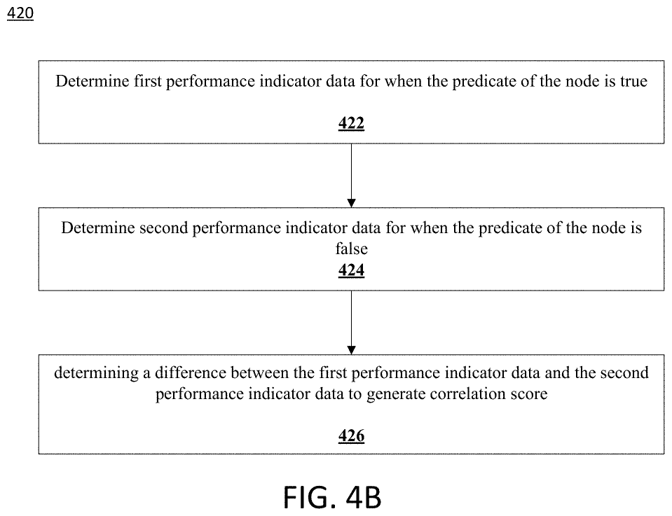

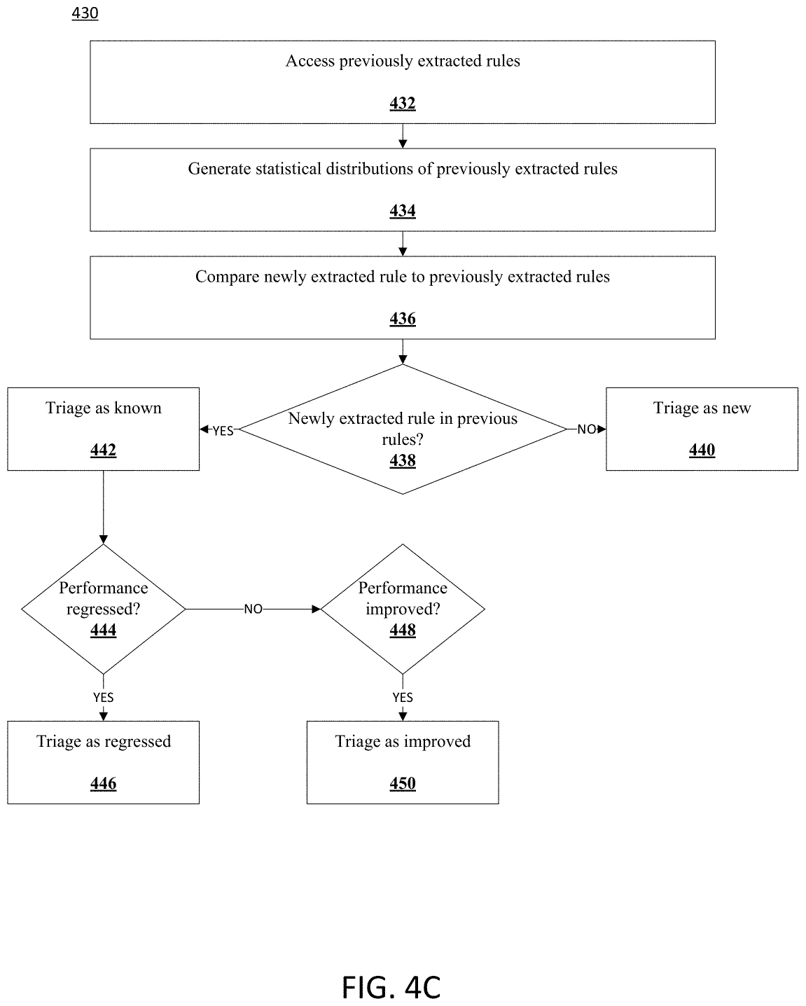

FIG. 4A depicts an example method 400 for diagnosing performance issues. At operation 402, log data is aggregated for a defined period of time. The log data includes a plurality of features and attributes regarding request handling over the defined period of time, and the log data may include any of the feature and/or attributes discussed above. For instance, the log data may be for a plurality of computing devices, such as log data provided by servers in data centers performing large-scale cloud services. The period of time may be selected by a user to analyze a particular period of time, such as when a performance regression is identified. The period of time may also be consistent and the method 400 may be performed on a repeated basis, such as every few hours, day, or week. For instance, the method 400 may be performed every day and the defined period of time is one day. In some examples, the log data may be aggregated into a data store of a diagnostics subsystem. In other examples, the log data may already be aggregated, in which case the log data may be accessed in operation 402 rather than aggregated. At operation 404, performance indicator data is aggregated for the defined period of time. The performance indicator data provides information about the targeting KPI, such as latency. For example, the aggregated performance indicator data may provide information about latency for each request received over the defined period of time. In some examples, the performance indicator data is included in the log data aggregated in operation 402. In such examples, aggregating the log data in operation 402 also includes aggregating the performance indicator data.

At operation 406, feature selection and/or sampling may be performed. As discussed above, feature selection and data sampling may be performed in examples with large amounts of log data to reduce the training time of the machine-learning model. The features or attributes that are most likely to be affecting KPI performance may be selected. The selection may be based on a manual input from an engineer or a technician. Automated feature selection may also be performed based on prior manual feature selections. As part of the feature selection process, the features of the log data may be automatically classified into continuous & categorical features. The cardinality of such features may also be measured. The categorized features may then be displayed to a user for selection, such as via a table similar to Table 1, above. The selected features will then be used to filter the log data to only the features selected. Data sampling processes may also be performed before or after the feature selection processes have been performed. Different types of data sampling may be utilized, such as random sampling, systematic sampling, stratified sampling, cluster sampling, etc. The log data may also be pre-processed and stratified, as discussed above, as part of the feature selection and data sampling operation 406. Performing the pre-processing, feature selection, stratification, and/or data sampling operation 406 results in a subset of log data that may be referred to as the processed log data.

At operation 408, a random forest model is trained based on the aggregated log data and the aggregated performance indicator data. Training the random forest model may be performed as discussed herein. For example, a particular type of KPI, such as latency, in the performance indicator data may be set as the target variable and the random forest model may then be trained on the aggregated log data. Training the random forest model generates a plurality of decision trees, which may be regression and/or classification trees. Each of the decision trees is represented by a plurality of nodes, including a root node and a plurality of child nodes. Each node may be represented by a predicate, as discussed above and depicted in FIGS. 2B-C.

At operation 410, at least a subset of the nodes in the decision trees of the random forest model are iterated over and analyzed. For example, a root node of a first decision tree may be analyzed, followed by the child nodes of the first decision tree. The nodes of the remaining decision trees may also be iterated over and analyzed. At operation 412, for each node that is iterated over and analyzed, a correlation score for the node is determined. The correlation score may be determined as described herein including performing method 420 in FIG. 4B, discussed further below.

At operation 414, for each node that has a correlation score greater than a predetermined threshold, a rule is extracted for the node and stored in a set of extracted rules. For instance, the correlation score may be compared to a predetermined threshold to determine that the correlation score is greater than the predetermined threshold. The predetermined threshold may be set automatically or manually based on a tolerance for variance in the KPI. Utilizing a threshold allows for noise in the model be excluded. For example, where the difference between the two performance indicator data is minimal, the predicate may not actually be affecting performance, or the performance affect may be minimal. The extracted rule is based on the predicate of the node that is being analyzed (e.g., the correlated predicate). In some examples, the extracted rule may be presented in the form of the predicate itself, or the rule may be based on the predicate but presented in a different format. For example, rather than the predicate in its original format, the rule may expand the predicate beyond the abbreviated attribute to provide additional context for the predicate. The rule may be further based on the scope predicates for the node being analyzed.

At operation 416, the set of the extracted rules is reported so that an engineer or technician may review the extracted rules to identify the root causes of the performance regression. The set of rules may be reported via a dashboard or through a message, such as an e-mail. For instance, the set of rules may be reported in the form of the report 300 in FIG. 3A and/or the report 310 in FIG. 3B. The set of extracted rules may also be ranked and/or triaged, and such ranking and triage data may be included in the report. Further, the correlation score, the performance impact, and/or the request/row count, may also be included in the report. A selectable query option configured to, upon selection, automatically generate and execute a query of the aggregated log data based on the extracted rule may also be included in the report.

FIG. 4B depicts an example method 420 for determining a correlation score for a node. At operation 422, first performance indicator data for when the predicate of the node is true is determined. The first performance indicator data may be determined from the aggregated log data and/or the aggregated performance indicator data. For instance, the first performance indicator data indicates the target KPI value for requests that satisfy the predicate of the node. The first performance indicator data may be the average performance indicator for all requests satisfying the predicate of the node. At operation 424, second performance indicator data for when the predicate of the node is true is determined. The second performance indicator data may be determined from the aggregated log data and/or the aggregated performance indicator data. For instance, the second performance indicator data indicates the target KPI value for requests that do not satisfy the predicate of the node. The second performance indicator data may be the average performance indicator for all requests not satisfying the predicate of the node. At operation 426, a difference between the first performance indicator data and the second performance indicator data is determined to generate the correlation score. The correlation score may be the actual difference between the first performance indicator data and the second performance indicator data. In other examples, the correlation score may be based on the difference between the first performance indicator data and the second performance indicator data, but the format may be changed. For instance, the units of the difference may be altered or the difference may be normalized against a standard.

FIG. 4C depicts an example method 430 for triaging extracted rules. At operation 432, a set of previously extracted rules are accessed for a previous time period. The previous time period may be any time period set by the user. For example, the previous time period may be the previous 14 days. At operation 434, statistical distributions are generated for the previously extracted rules from the previous time period. The statistical distributions may be for the frequency that a particular rule was generated over the time period. The statistical distributions may also be for the correlation score or performance impact of the rules in the previously extracted rules. For instance, for a particular rule in the previously extracted rules, an average value may be determined for the target KPI, such as latency. In other examples, a Gaussian distribution of the value of the target KPI may be generated for each of the rules in the previously extracted rules.

At operation 436, a newly extracted rule, such as a rule extracted from method 400 depicted in FIG. 4A, is compared to the previously extracted rules for the previous time period. The comparison may include comparing the rule itself to the previously extracted rules and/or comparing the correlation score and the performance impact to the corresponding correlations scores and performance impacts of the previously extracted rules. Based on the comparisons made in operation 436, a series of decisions may be made to properly triage the newly extracted rule. For example, at operation 438, a determination is made as to whether the newly extracted rule is in the previously extracted rule. That is, a determination is made as to whether the newly extracted rule has been previously extracted within the previous time period, such as 14 days. If the newly extracted rule has not been previously extracted within the time period, the newly extracted rule is triaged as new in operation 440. If the newly extracted rule has been previously extracted, the newly extracted rule is triaged as known at operation 442. If the newly extracted rule is triaged as known, the method 430 may continue to analyze and further triage the newly extracted rule. For instance, the correlation score and/or performance impact of the newly extracted rule may then be compared to correlation scores and/or performance impacts of the corresponding previously extracted rules.

At operation 444, a determination may be made as to whether performance has regressed. The regression determination may be made based on a comparison of the correlation score of the newly extracted rule to statistical distribution of the correlation score for the corresponding previously extracted rule generated at operation 434. If the correlation score for the newly extracted rule is greater than the average correlation score for the corresponding previously extracted rule, the newly extracted rule may be triaged as regressed in operation 446. In some examples, the newly extracted rule may only be triaged as regressed if the correlation score for the newly extracted rule is at least one standard deviation greater than the average correlation score for the corresponding previously extracted rules. If the correlation score of the newly extracted rule is not greater than the average of the corresponding previously extracted rules (or not greater than one standard deviation), a determination is made as to whether performance relating to the newly extracted rule has improved at operation 448. If the correlation score for the newly extracted rule is less than the average correlation score for the corresponding previously extracted rule, the newly extracted rule may be triaged as improved in operation 450. In some examples, the newly extracted rule may only be triaged as improved if the correlation score for the newly extracted rule is at least one standard deviation less than the average correlation score for the corresponding previously extracted rules. While the above determinations are described as being made based on the correlation scores, the determinations may also be made alternatively or additionally based on the performance impacts of the extracted rules.

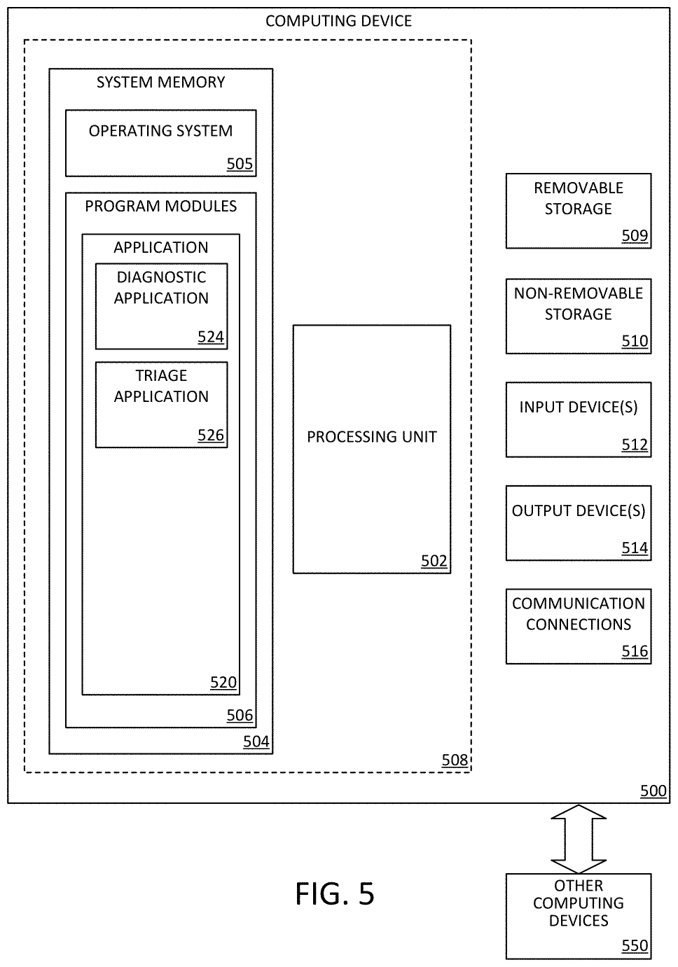

FIGS. 5-8 and the associated descriptions provide a discussion of a variety of operating environments in which aspects of this disclosure and the present technology may be practiced. However, the devices and systems illustrated and discussed with respect to FIGS. 5-8 are for purpose of example and illustration and are not limiting of a vast number of computing device configurations that may be utilized for practicing aspects of the disclosure, described herein.

FIG. 5 is a block diagram illustrating physical components (e.g., hardware) of a computing device 500 with which aspects of the disclosure may be practiced. The computing device components described below may be suitable for the computing devices described above, including the computing devices 102, 104, and 106 in FIG. 1. In a basic configuration, the computing device 500 may include at least one processing unit 502 and a system memory 504. Depending on the configuration and type of computing device, the system memory 504 may comprise, but is not limited to, volatile storage (e.g., random access memory), non-volatile storage (e.g., read-only memory), flash memory, or any combination of such memories.

The system memory 504 may include an operating system 505 and one or more program modules 506 suitable for running software application 520, such as one or more components supported by the systems described herein. As examples, system memory 504 may store diagnostic application 524 and triage application 526. Diagnostic application 524 may perform operations of the diagnostics subsystem and the triage application may perform operations associated with the triage subsystem. The operating system 505, for example, may be suitable for controlling the operation of the computing device 500.

Furthermore, embodiments of the disclosure may be practiced in conjunction with a graphics library, other operating systems, or any other application program and is not limited to any particular application or system. This basic configuration is illustrated in FIG. 5 by those components within a dashed line 508. The computing device 500 may have additional features or functionality. For example, the computing device 500 may also include additional data storage devices (removable and/or non-removable) such as, for example, magnetic disks, optical disks, or tape. Such additional storage is illustrated in FIG. 5 by a removable storage device 509 and a non-removable storage device 510.

As stated above, a number of program modules and data files may be stored in the system memory 504. While executing on the processing unit 502, the program modules 506 (e.g., application 520) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 500 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 500 may also have one or more input device(s) 512 such as a keyboard, a mouse, a pen, a sound or voice input device, a touch or swipe input device, etc. The output device(s) 514 such as a display, speakers, a printer, etc. may also be included. The aforementioned devices are examples and others may be used. The computing device 500 may include one or more communication connections 516 allowing communications with other computing devices 550. Examples of suitable communication connections 516 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 504, the removable storage device 509, and the non-removable storage device 510 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

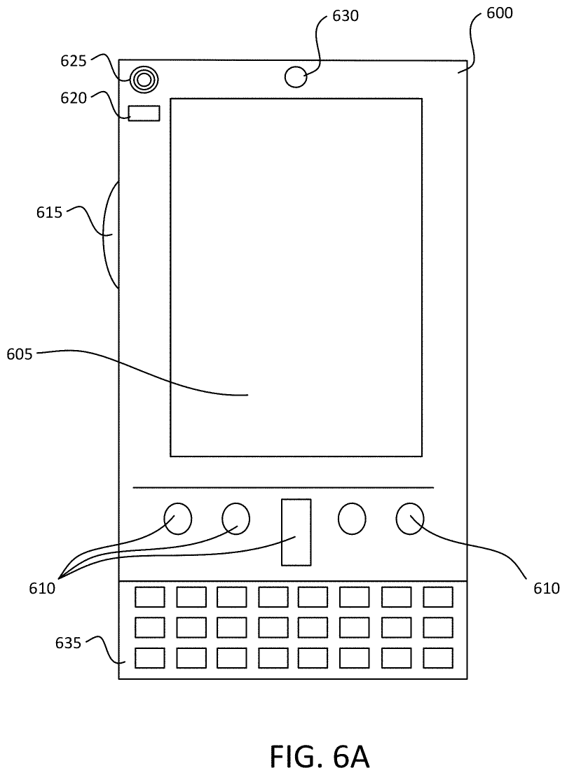

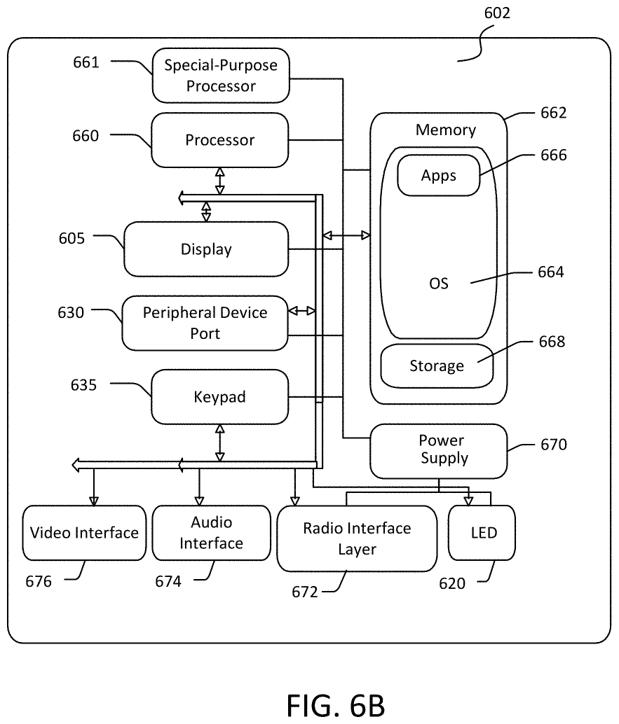

FIGS. 6A and 6B illustrate a mobile computing device 600, for example, a mobile telephone, a smart phone, wearable computer (such as a smart watch), a tablet computer, a laptop computer, and the like, with which embodiments of the disclosure may be practiced. In some aspects, the client may be a mobile computing device. With reference to FIG. 6A, one aspect of a mobile computing device 600 for implementing the aspects is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. The display 605 of the mobile computing device 600 may also function as an input device (e.g., a touch screen display).

If included, an optional side input element 615 allows further user input. The side input element 615 may be a rotary switch, a button, or any other type of manual input element. In alternative aspects, mobile computing device 600 may incorporate more or less input elements. For example, the display 605 may not be a touch screen in some embodiments.

In yet another alternative embodiment, the mobile computing device 600 is a portable phone system, such as a cellular phone. The mobile computing device 600 may also include an optional keypad 635. Optional keypad 635 may be a physical keypad or a “soft” keypad generated on the touch screen display.

In various embodiments, the output elements include the display 605 for showing a graphical user interface (GUI), a visual indicator 620 (e.g., a light emitting diode), and/or an audio transducer 625 (e.g., a speaker). In some aspects, the mobile computing device 600 incorporates a vibration transducer for providing the user with tactile feedback. In yet another aspect, the mobile computing device 600 incorporates input and/or output ports, such as an audio input (e.g., a microphone jack), an audio output (e.g., a headphone jack), and a video output (e.g., a HDMI port) for sending signals to or receiving signals from an external device.

FIG. 6B is a block diagram illustrating the architecture of one aspect of a mobile computing device. That is, the mobile computing device 600 can incorporate a system (e.g., an architecture) 602 to implement some aspects. In one embodiment, the system 602 is implemented as a “smart phone” capable of running one or more applications (e.g., browser, e-mail, calendaring, contact managers, messaging clients, games, and media clients/players). In some aspects, the system 602 is integrated as a computing device, such as an integrated personal digital assistant (PDA) and wireless phone.

One or more application programs 666 may be loaded into the memory 662 and run on or in association with the operating system 664. Examples of the application programs include phone dialer programs, e-mail programs, personal information management (PIM) programs, word processing programs, spreadsheet programs, Internet browser programs, messaging programs, and so forth. The system 602 also includes a non-volatile storage area 668 within the memory 662. The non-volatile storage area 668 may be used to store persistent information that should not be lost if the system 602 is powered down. The application programs 666 may use and store information in the non-volatile storage area 668, such as e-mail or other messages used by an e-mail application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600 described herein (e.g., search engine, extractor module, relevancy ranking module, answer scoring module, etc.).

The system 602 has a power supply 670, which may be implemented as one or more batteries. The power supply 670 might further include an external power source, such as an AC adapter or a powered docking cradle that supplements or recharges the batteries.

The system 602 may also include a radio interface layer 672 that performs the function of transmitting and receiving radio frequency communications. The radio interface layer 672 facilitates wireless connectivity between the system 602 and the “outside world,” via a communications carrier or service provider. Transmissions to and from the radio interface layer 672 are conducted under control of the operating system 664. In other words, communications received by the radio interface layer 672 may be disseminated to the application programs 666 via the operating system 664, and vice versa.

The visual indicator 620 may be used to provide visual notifications, and/or an audio interface 674 may be used for producing audible notifications via the audio transducer 625. In the illustrated embodiment, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input, such as to facilitate a telephone conversation. In accordance with embodiments of the present disclosure, the microphone may also serve as an audio sensor to facilitate control of notifications, as will be described below. The system 602 may further include a video interface 676 that enables an operation of an on-board camera 630 to record still images, video stream, and the like.

A mobile computing device 600 implementing the system 602 may have additional features or functionality. For example, the mobile computing device 600 may also include additional data storage devices (removable and/or non-removable) such as, magnetic disks, optical disks, or tape. Such additional storage is illustrated in FIG. 6B by the non-volatile storage area 668.

Data/information generated or captured by the mobile computing device 600 and stored via the system 602 may be stored locally on the mobile computing device 600, as described above, or the data may be stored on any number of storage media that may be accessed by the device via the radio interface layer 672 or via a wired connection between the mobile computing device 600 and a separate computing device associated with the mobile computing device 600, for example, a server computer in a distributed computing network, such as the Internet. As should be appreciated such data/information may be accessed via the mobile computing device 600 via the radio interface layer 672 or via a distributed computing network. Similarly, such data/information may be readily transferred between computing devices for storage and use according to well-known data/information transfer and storage means, including electronic mail and collaborative data/information sharing systems.

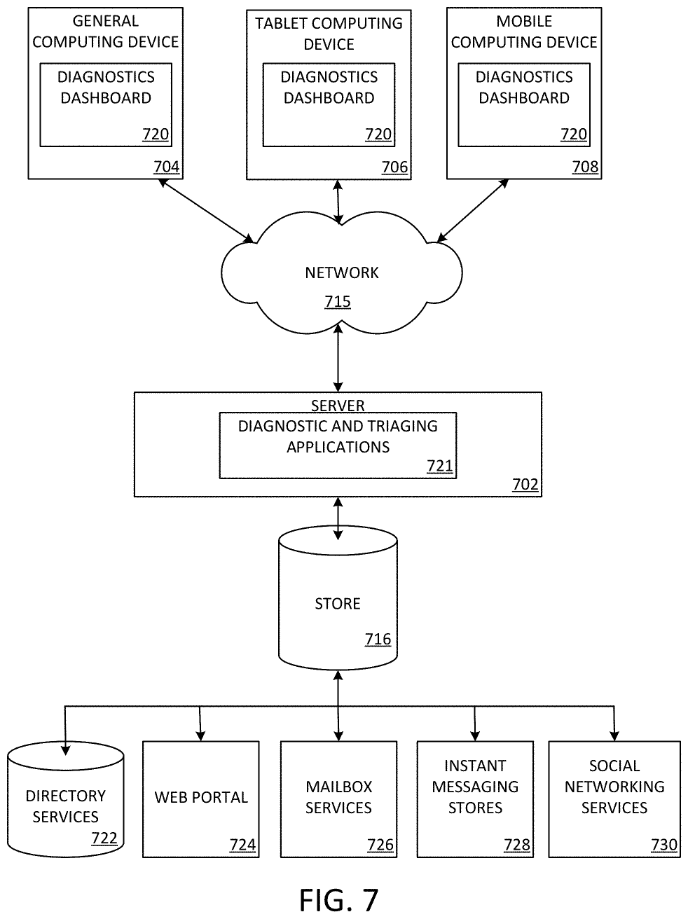

FIG. 7 illustrates one aspect of the architecture of a system for processing data received at a computing system from a remote source, such as a personal computer 704, tablet computing device 706, or mobile computing device 708, as described above. Content displayed at server device 702 may be stored in different communication channels or other storage types. For example, various documents may be stored using a directory service 722, a web portal 724, a mailbox service 726, an instant messaging store 728, or a social networking site 730.

A diagnostics dashboard 720 may be employed by a client that communicates with server device 702, and/or the diagnostic and triaging applications 721 may be employed by server device 702. Accordingly, the extracted rules and reports may be provided by the server 702 to the client devices 704-708 via the dashboard application 720. The server device 702 may provide data to and from a client computing device such as a personal computer 704, a tablet computing device 706 and/or a mobile computing device 708 (e.g., a smart phone) through a network 715. By way of example, the computer system described above may be embodied in a personal computer 704, a tablet computing device 706 and/or a mobile computing device 708 (e.g., a smart phone). Any of these embodiments of the computing devices may obtain content from the store 716, in addition to receiving graphical data useable to be either pre-processed at a graphic-originating system, or post-processed at a receiving computing system.

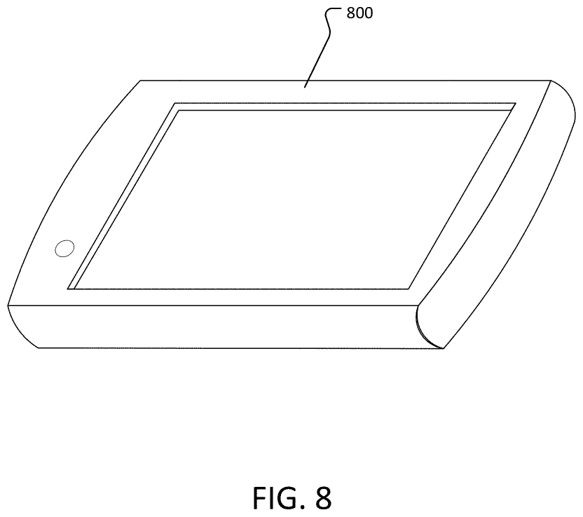

FIG. 8 illustrates an exemplary tablet computing device 800 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

The present technology has also been experimentally tested and produced positive results. The experiment was implemented using Microsoft Azure and a Hadoop like MapReduce cluster for large scale data analytics referred to herein as Cosmos. Cosmos supported a SQL-like query language for running MapReduce jobs. Modules using this query language for the data sampling and model training were utilized. Also, the rule extraction and triaging module were implemented using C# (.NET Framework v4.5) and SQL. The technology was operationalized for both retrospective analysis (e.g., diagnosing regressions in the past) and, also, for near real time analysis where service owners identify root causes of ongoing incidents.

For data ingestion, a data loader process which runs at regular cadence on the servers was used to scrub the users Personally Identifiable Information (PII) from the log data and upload that raw log data to an HDF S-like data store used by Nebula. Those logs were then processed by custom MapReduce jobs by the respective service owners for various purposes like analytics, monitoring, and debugging. Those logs were then used for the implementation of the experiment. The data ingestion job was implemented using a job scheduler for Cosmos called Avocado. The cadence may depend on the service requirements, but it can be in near real time or at fixed time intervals, such as hourly. Sometimes logs from multiple sources might also be aggregated for diagnostics. For instance, in some examples, request logs and infrastructure logs may be used to identify root causes of performance issues related to infrastructure failures.

For the Random Forest model training, we use a machine-learning (ML) library for Cosmos was used. The ML library implemented a distributed version of the CART algorithm for training random forest models. Similar distributed implementations are available for MapReduce systems like Hadoop and Spark, as described in J. Chen, K. Li, Z. Tang, K. Bilal, S. Yu, C. Weng, and K. Li, “A parallel random forest algorithm for big data in a spark cloud computing environment,” IEEE Transactions on Parallel and Distributed Systems, vol. 28, no. 4, pp. 919-933, 2017; J. Han, Y. Liu, and X. Sun, “A scalable random forest algorithm based on mapreduce,” in 2013 IEEE 4th International Conference on Software Engineering and Service Science, pp. 849-852, IEEE, 2013; and B. Li, X. Chen, M. J. Li, J. Z. Huang, and S. Feng, “Scalable random forests for massive data,” in Pacific-Asia Conference on Knowledge Discovery and Data Mining, pp. 135-146, Springer, 2012. The experiment implemented a custom library in C#.NET framework 4.5 for analyzing the random forest model output and generating the ranked list of rules. The library uploaded the results to an SQL cloud database. The Avocado job for model training and analysis was triggered once the data is ingested. To avoid having race conditions between the data and the model jobs, a dependency between the two jobs was utilized. Dynamic Cosmos MapReduce query generation was also enabled for each of the rules generated the experimental implementation. The query generation features may be triggered from the selection of a “Query Logs” link which automatically runs a Cosmos job for mining the logs.

The experimental implementation was also applied to two experimental studies. The first experimental study was referred to as the “Orion” experiment. In the Orion experiment, a first service, Andromeda, was involved. Andromeda was a large commercial collaboration and email service used by approximately 100 million users. That service employed a horizontal scale-out architecture based on sharding by users across approximately 100,000 servers across the globe that have both compute and storage capacity.

Orion was the system that does smart request routing as the request routing plane. Orion ran on an IIS web service and had multiple dependencies on internal as well as external sub-systems like shared caches, auth components, microservices, databases, etc. It was a massively distributed service that currently sustained a peak throughput of about 1 million requests/second, that target about 1 billion shards, provisioned across about 100,000 Andromeda servers, spread over about 100 data-centers worldwide. Andromeda had 1st party, 2nd party and 3rd party partners. Each of those partners had their own SLAs that required, for example, latency less than RTT (round trip time)+5 ms at the 99th percentile. Before a user request landed on its shard's location, it was processed by multiple routing applications like load balancer, network layer, and multiple hops in request routing. The goal of using an automated root cause identification system for Orion was to not only detect regression but also to find existing bugs and design flaws resulting in high latency. The experimental implementation of the present technology was applied in Orion for identifying root causes of latency issues, and nine known and fifteen unknown issues were identified via the rule extraction techniques of the present technology.

Another experiment, referred to as the “Domino” experiment was also performed. In that experiment, Domino was a global scale internet measurement platform. It was designed to perform client-to-cloud path measurements from users around the world to a company's first-party and third-party endpoints. The experimental implementation of the technology was directed towards analyzing the KPI of failure rate. Failure rate was defined as the number of failed Domino requests divided by the number of attempted requests in each time bucket. The scale and diversity of measurements being performed often resulted in the failure rate behaving in unexpected ways. One such issue was that certain large-scale client networks were facing higher failure rate during day times (in local time for the clients) as compared to night times. Applying the experimental implementation of the technology found 16 unknown issues and 1 known issue which were causing high failure rates.

Other attempts to perform diagnostics have been made, but the present technology improves on such attempts. For instance Bodik et. al (P. Bodik, M. Goldszmidt, A. Fox, D. B. Woodard, and H. Andersen, “Fingerprinting the datacenter: automated classification of performance crises,” in Proceedings of the 5th European conference on Computer systems, pp. 111-124, ACM, 2010) rely on anomaly signatures of known issues along with regression models for diagnosing failures in data centers. Chen et. al (M. Chen, A. X. Zheng, J. Lloyd, M. I. Jordan, and E. Brewer, “Failure diagnosis using decision trees,” in International Conference on Autonomic Computing, 2004. Proceedings., pp. 36-43, May 2004) use classification trees to root cause failure rates in a large internet web site like eBay. Cohen et. al (Cohen, J. S. Chase, M. Goldszmidt, T. Kelly, and J. Symons, “Correlating instrumentation data to system states: A building block for automated diagnosis and control.,” in OSDI, vol. 4, pp. 16-16, 2004) use Tree-Augmented Bayesian Networks to identify combinations of system level metrics which are correlated with non-compliance with SLAs. Nair et. al (V. Nair, A. Raul, S. Khanduja, V. Bahirwani, Q. Shao, S. Sellamanickam,

S. Keerthi, S. Herbert, and S. Dhulipalla, “Learning a hierarchical monitoring system for detecting and diagnosing service issues,” in Proceedings of the 21th ACM SIGKDD International Conference on Knowledge Discovery and Data Mining, pp. 2029-2038, ACM, 2015) use hierarchical detectors with time series anomaly detection to diagnose issues. Duan (S. Duan, S. Babu, and K. Munagala, “Fa: A system for automating failure diagnosis,” in 2009 IEEE 25th International Conference on Data Engineering, pp. 1012-1023, IEEE, 2009) and Farshchi (M. Farshchi, J.-G. Schneider, I. Weber, and J. Grundy, “Experience report: Anomaly detection of cloud application operations using log and cloud metric correlation analysis,” in 2015 IEEE 26th International Symposium on Software Reliability Engineering (ISSRE), pp. 24-34, IEEE, 2015) combine clustering and anomaly detection techniques for root causing. However, clustering and anomaly detection based methods are not feasible for high cardinality data. The present technology provides improvements over those works, in part, by providing end-to-end system which is capable of handling heterogeneous and high cardinality (on the order of 1 million) data, diagnosing different types of KPIs, automatically ranking and triaging the discovered issues; and detecting previously unknown issues.

Experiments were also performed using different methods and techniques and the results demonstrate an improvement by the present technology. For example, a single decision tree method, such as the one in M. Chen, A. X. Zheng, J. Lloyd, M. I. Jordan, and E. Brewer, “Failure diagnosis using decision trees,” in International Conference on Autonomic Computing, 2004, Proceedings., pp. 36-43, May 2004, was used as a baseline. was compared to the random forest model implementation of the present technology. The random forest model of the present technology was found to discover four times more valid issues. In addition, the random forest model implementation had a 9.1% higher precision than the single decision tree baseline.

The embodiments described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices may be employed to perform the functionality disclosed herein without departing from the scope of the disclosure. In addition, some aspects of the present disclosure are described above with reference to block diagrams and/or operational illustrations of systems and methods according to aspects of this disclosure. The functions, operations, and/or acts noted in the blocks may occur out of the order that is shown in any respective flowchart. For example, two blocks shown in succession may in fact be executed or performed substantially concurrently or in reverse order, depending on the functionality and implementation involved.

This disclosure describes some embodiments of the present technology with reference to the accompanying drawings, in which only some of the possible embodiments were shown. Other aspects may, however, be embodied in many different forms and should not be construed as limited to the embodiments set forth herein. Rather, these embodiments were provided so that this disclosure was thorough and complete and fully conveyed the scope of the possible embodiments to those skilled in the art. Further, as used herein and in the claims, the phrase “at least one of element A, element B, or element C” is intended to convey any of: element A, element B, element C, elements A and B, elements A and C, elements B and C, and elements A, B, and C. Further, one having skill in the art will understand the degree to which terms such as “about” or “substantially” convey in light of the measurements techniques utilized herein. To the extent such terms may not be clearly defined or understood by one having skill in the art, the term “about” shall mean plus or minus ten percent.

Although specific embodiments are described herein, the scope of the technology is not limited to those specific embodiments. Moreover, while different examples and embodiments may be described separately, such embodiments and examples may be combined with one another in implementing the technology described herein. One skilled in the art will recognize other embodiments or improvements that are within the scope and spirit of the present technology. Therefore, the specific structure, acts, or media are disclosed only as illustrative embodiments. The scope of the technology is defined by the following claims and any equivalents therein.

In one aspect, the technology relates to a computer-implemented method comprising: accessing log data, for a plurality of computing devices, for a defined period of time; accessing performance indicator data, for the plurality of computing devices, for the defined period of time; training a random forest model with the aggregated log data and the aggregated performance indicator data to generate a plurality of trained decision trees, wherein each of the plurality of decision trees includes a plurality of nodes represented by predicates; determining a correlation score for a node in the plurality of decision trees; based on the determined correlation score, extracting a rule for the node, wherein the rule is based on the predicate of the node; and reporting the extracted rule.

In an example, determining the correlation score for the node in the plurality of decision trees comprises: determining first performance indicator data for when the predicate of the node is true; determining second performance indicator data for when the predicate of the node is false; and determining a difference between the first performance indicator data and the second performance indicator data, wherein the determined correlation score for the node is based on the determined difference between the first difference between the first performance indicator data and the second performance indicator data. In another example, the method further includes triaging the rule based on previously extracted rules for a time period prior to the defined period of time. In still another example, triaging the rule includes triaging the rule into one or more of the following triage categories: new, regressed, known, or improved. In yet another example, the method further includes receiving a selection of features of the log data for which the random forest model is to be trained, and wherein the random forest model is trained based on a subset of the log data corresponding to the selected features. In still yet another example, the method further includes sampling the aggregated log data, and wherein the random forest model is trained based on the sampled aggregated log data.

In another example, reporting the extracted rule comprises generating an electronic communication that includes: the extracted rule; the correlation score for the extracted rule; and a selectable query option configured to, upon selection, automatically generate and execute a query of the aggregated log data based on the extracted rule. In yet another example, the method further includes converting the trained random forest model into a text-based set of decision tree objects corresponding to the plurality of decision trees. In still another example, extracted rule includes: a correlated predicate that includes the predicate of the node; and a scope predicate that includes the predicate of each intervening node between the node and a root node of the decision tree of the node.

In another aspect, the technology relates to a system comprising at least one processor; and memory storing instruction that, when executed by the at least one processor, cause the system to perform a set of operations. The set of operations include accessing log data, for a plurality of computing devices, for a defined period of time; accessing performance indicator data, for the plurality of computing devices, for the defined period of time; training a random forest model with the aggregated log data and the aggregated performance indicator data to generate a plurality of trained decision trees, wherein each of the plurality of decision trees includes a plurality of nodes represented by predicates; determining a correlation score for a node in the plurality of decision trees; based on the determined correlation score, extracting a rule for the node, wherein the rule is based on the predicate of the node; triaging the rule based on previously extracted rules for a time period prior to the defined period of time, wherein triaging the rule includes triaging the rule into one or more of the following triage categories: new, regressed, known, or improved; and reporting the extracted rule and the triaged category for the rule.

In an example, determining the correlation score for the node in the plurality of decision trees comprises the following operations: determining first performance indicator data for when the predicate of the node is true; determining second performance indicator data for when the predicate of the node is false; and determining a difference between the first performance indicator data and the second performance indicator data, wherein the determined correlation score for the node is based on the determined difference between the first difference between the first performance indicator data and the second performance indicator data. In another example, the operations further comprise receiving a selection of features of the log data for which the random forest model is to be trained, and wherein the random forest model is trained based on a subset of the log data corresponding to the selected features. In yet another example, the predicate is based on one of the selected features. In still another example, the operations further comprise sampling the aggregated log data, and wherein the random forest model is trained based on the sampled aggregated log data.

In another example, reporting the extracted rule comprises generating an electronic communication that includes: the extracted rule; the correlation score for the extracted rule; and a selectable query option configured to, upon selection, automatically generate and execute a query of the aggregated log data based on the extracted rule. In still another example, the operations further comprise: generating a performance impact for the extracted rule based on the correlation score and a number of requests that satisfy the predicate of the node; and wherein reporting the extracted rule includes reporting the performance impact for the extracted rule.

In another aspect, the technology relates to a computer-implemented method comprising: aggregating log data for a defined period of time; aggregating performance indicator data for the defined period of time; training a random forest model with the aggregated log data and the aggregated performance indicator data to generate a plurality of trained decision trees, wherein each of the plurality of decision trees include nodes represented by predicates; iterating through at least a subset of the nodes; at each node of the subset of the nodes, determining a correlation score for the node; for each node having a correlation score greater than a predetermined threshold, extracting a rule for the node, based on the predicate of the node, to generate a set of extracted rules; and reporting the set of extracted rules and the determined correlation score for each of the extracted rules.

In an example, determining the correlation score for the node includes: determining first performance indicator data for when the predicate of the node is true; determining second performance indicator data for when the predicate of the node is false; determining a difference between the first performance indicator data and the second performance indicator. In another example, reporting the set of extracted rules and the determined correlation score for each of the extracted rules comprises generating an electronic communication that includes: the set of extracted rules; the determined correlation score for each of the extracted rules; and a selectable query option for each of the extracted rules, wherein each selectable query option is configured to, upon selection, automatically generate and execute a query of the aggregated log data based on the extracted rule for which the selectable query option corresponds. In yet another example, the method further includes triaging the rule based on previously extracted rules for a time period prior to the defined period of time, wherein triaging the rule includes triaging the rule into one or more of the following triage categories: new, regressed, known, or improved.

What is claimed is:

1. A computer-implemented method comprising:
accessing log data, for a plurality of computing devices, for a defined period of time;
accessing performance indicator data, for the plurality of computing devices, for the defined period of time;
training a random forest model with the aggregated log data and the aggregated performance indicator data to generate a plurality of trained decision trees, wherein each of the plurality of decision trees includes a plurality of nodes represented by predicates;
determining a correlation score for a node in the plurality of decision trees;
based on the determined correlation score, extracting a rule for the node, wherein the rule is based on the predicate of the node; and
reporting the extracted rule.

2. The computer-implemented method of claim 1, wherein determining the correlation score for the node in the plurality of decision trees comprises:
determining first performance indicator data for when the predicate of the node is true;
determining second performance indicator data for when the predicate of the node is false; and
determining a difference between the first performance indicator data and the second performance indicator data, wherein the determined correlation score for the node is based on the determined difference between the first difference between the first performance indicator data and the second performance indicator data.

3. The computer-implemented method of claim 1, further comprising triaging the rule based on previously extracted rules for a time period prior to the defined period of time.

4. The computer-implemented method of claim 3, wherein triaging the rule includes triaging the rule into one or more of the following triage categories: new, regressed, known, or improved.

5. The computer-implemented method of claim 1, further comprising receiving a selection of features of the log data for which the random forest model is to be trained, and wherein the random forest model is trained based on a subset of the log data corresponding to the selected features.

6. The computer-implemented method of claim 1, further comprising sampling the aggregated log data, and wherein the random forest model is trained based on the sampled aggregated log data.

7. The computer-implemented method of claim 1, wherein reporting the extracted rule comprises generating an electronic communication that includes:
the extracted rule;
the correlation score for the extracted rule; and
a selectable query option configured to, upon selection, automatically generate and execute a query of the aggregated log data based on the extracted rule.

8. The computer-implemented method of claim 1, further comprising converting the trained random forest model into a text-based set of decision tree objects corresponding to the plurality of decision trees.

9. The computer-implement method of claim 1, wherein the extracted rule includes:
a correlated predicate that includes the predicate of the node; and
a scope predicate that includes the predicate of each intervening node between the node and a root node of the decision tree of the node.

10. A system comprising:
at least one processor; and
memory storing instruction that, when executed by the at least one processor, cause the system to perform a set of operations comprising:
accessing log data, for a plurality of computing devices, for a defined period of time;
accessing performance indicator data, for the plurality of computing devices, for the defined period of time;
training a random forest model with the aggregated log data and the aggregated performance indicator data to generate a plurality of trained decision trees, wherein each of the plurality of decision trees includes a plurality of nodes represented by predicates;
determining a correlation score for a node in the plurality of decision trees;
based on the determined correlation score, extracting a rule for the node, wherein the rule is based on the predicate of the node;
triaging the rule based on previously extracted rules for a time period prior to the defined period of time, wherein triaging the rule includes triaging the rule into one or more of the following triage categories: new, regressed, known, or improved; and
reporting the extracted rule and the triaged category for the rule.

11. The system of claim 10, wherein determining the correlation score for the node in the plurality of decision trees comprises the following operations:
determining first performance indicator data for when the predicate of the node is true;
determining second performance indicator data for when the predicate of the node is false; and
determining a difference between the first performance indicator data and the second performance indicator data, wherein the determined correlation score for the node is based on the determined difference between the first difference between the first performance indicator data and the second performance indicator data.

12. The system of claim 10, wherein the operations further comprise receiving a selection of features of the log data for which the random forest model is to be trained, and wherein the random forest model is trained based on a subset of the log data corresponding to the selected features.

13. The system of claim 12, wherein the predicate is based on one of the selected features.

14. The system of claim 10, wherein the operations further comprise sampling the aggregated log data, and wherein the random forest model is trained based on the sampled aggregated log data.

15. The system of claim 10, wherein reporting the extracted rule comprises generating an electronic communication that includes:
the extracted rule;
the correlation score for the extracted rule; and
a selectable query option configured to, upon selection, automatically generate and execute a query of the aggregated log data based on the extracted rule.

16. The system of claim 10, wherein the operations further comprise:
generating a performance impact for the extracted rule based on the correlation score and a number of requests that satisfy the predicate of the node; and
wherein reporting the extracted rule includes reporting the performance impact for the extracted rule.

17. A computer-implemented method comprising:
aggregating log data for a defined period of time;
aggregating performance indicator data for the defined period of time;
training a random forest model with the aggregated log data and the aggregated performance indicator data to generate a plurality of trained decision trees, wherein each of the plurality of decision trees include nodes represented by predicates;
iterating through at least a subset of the nodes;
at each node of the subset of the nodes, determining a correlation score for the node;
for each node having a correlation score greater than a predetermined threshold, extracting a rule for the node, based on the predicate of the node, to generate a set of extracted rules; and
reporting the set of extracted rules and the determined correlation score for each of the extracted rules.

18. The computer-implemented method of claim 17, wherein determining the correlation score for the node includes:
determining first performance indicator data for when the predicate of the node is true;
determining second performance indicator data for when the predicate of the node is false;
determining a difference between the first performance indicator data and the second performance indicator.

19. The computer-implemented method of claim 17, wherein reporting the set of extracted rules and the determined correlation score for each of the extracted rules comprises generating an electronic communication that includes:
the set of extracted rules;
the determined correlation score for each of the extracted rules; and
a selectable query option for each of the extracted rules, wherein each selectable query option is configured to, upon selection, automatically generate and execute a query of the aggregated log data based on the extracted rule for which the selectable query option corresponds.

20. The computer-implemented method of claim 17, further comprising triaging the rule based on previously extracted rules for a time period prior to the defined period of time, wherein triaging the rule includes triaging the rule into one or more of the following triage categories: new, regressed, known, or improved.
